(19) United States
(12) Patent Application Publication
(10) Pub. No.: US 2025/0259807 A1
(43) Pub. Date: Aug. 14, 2025

(54) MOTORIZED HIGH VOLTAGE IN-LINE DISCONNECT SWITCH WITH SOLAR PANEL ICE SHIELDS

(71) Applicant: CLEAVELAND/PRICE INC., TRAFFORD, PA (US)

(72) Inventor: ANGELO ROMETO, NORTH HUNTINGDON, PA (US)

(73) Assignee: CLEAVELAND/PRICE INC., TRAFFORD, PA (US)

(21) Appl. No.: 18/899,864

(22) Filed: Sep. 27, 2024

Related U.S. Application Data
(60) Provisional application No. 63/551,227, filed on Feb. 8, 2024.

(51) Int. Cl. H01H 31/02; H01H 31/28; H02S 40/38

(52) U.S. Cl. CPC H01H 31/02; H01H 31/28; H02S 40/38

(57) ABSTRACT

A high voltage motorized in-line air break disconnect switch having a rotating switch blade. The high voltage in-line switch including a solar panel ice shield unit. The solar panel ice shield unit including at least one solar panel operatively attached to an electric power line conductor. The solar panel ice shield unit configured to shield the moving contact end of the elongated switch blade from ice build-up when the high voltage motorized in-line air break disconnect switch is in the final open non-conductive switch position. The solar panel ice shield unit configured to collect more solar energy for electric charging of the battery. A solar panel ice shield unit support frame is configured to support the at least one solar panel and is configured to prevent corona. Additional solar panel units, not used as ice shields, can be attached to the electric power line conductor for collecting additional solar energy.

### CROSS-REFERENCE TO RELATED APPLICATION

This application claims the benefit of U.S. Provisional Application No. 63/551,227 filed Feb. 8, 2024, which is incorporated herein by reference in its entirety.

### BACKGROUND OF THE INVENTION

The present invention relates generally to an air break disconnect switch for high voltage electrical applications and, more particularly, to a motorized in-line high voltage air break disconnect switch that mounts in-line with a transmission line conductor without the need of a group operated switch with associated ground supported mounting structure. Such a motorized high voltage in-line disconnect switch hangs from and is supported by its associated transmission line.

A motorized high voltage in-line air break disconnect switch can be used to sectionalize long transmission lines, disconnect lines from substations, serve as a line tap switch, and serve as a temporary maintenance switch, for example. It allows for easy, cost efficient sectionalizing of high voltage transmission lines and isolation in high voltage substations.

One example of such a motorized high voltage in-line air break disconnect switch is disclosed in U.S. Pat. No. 9,881,755 B1 by Charles M. Cleaveland issued on Jan. 30, 2018, to Cleaveland/Price Inc., the present assignee, entitled “Motorized High Voltage In-Line Disconnect Switch With Hand-Held Communication System to Prevent Unwanted Operation”. This switch includes an elongated strain insulator supporting an elongated rotating switch blade having a hinge contact end and a break jaw contact end. The rotating switch blade is rotatable at the hinge contact end during opening and closing of the switch. The switch includes a battery powered motor connected to an output shaft to cause the hinge end of the switch blade to rotate when energized to open or close the switch. A communication system actuates the motor to cause the switch to open and close as desired. This patent discloses embodiments of a vertical break and a side break high voltage in-line motorized air break disconnect switch. Both the vertical break and side break switches include an elongated switch blade that is rotatable at one end of the switch blade, i.e., about the hinge end.

Another example of such a motorized high voltage in-line air break disconnect switch including a hinge mounted rotating switch blade is disclosed in U.S. Pat. No. 9,966,207 B1 by Charles M. Cleaveland issued May 8, 2018, to Cleaveland/Price Inc., the present assignee, entitled “Motorized High Voltage In-Line Disconnect Switch with Communication System Controls”. This switch includes a rotating switch blade that is operated by a communication system controlled battery powered motor that may include a switch mounted communication device, such as a radio which is controlled by another such communication device located in an electric utility control room to open and close the switch. This patent also discloses embodiments of a vertical break and a side break high voltage in-line motorized air break disconnect switch. Both the vertical break and side break switches include an elongated switch blade that is rotatable at one end of the switch blade, i.e., about the hinge end.

The said U.S. Pat. No. 9,881,755 B1 and the said U.S. Pat. No. 9,966,207 B1 are both incorporated herein by reference in their entireties as though fully set forth. Information regarding the installation, operations, adjustment, and many other aspects of the switches disclosed in said U.S. Pat. No. 9,881,755 B1 and said U.S. Pat. No. 9,966,207 B1 is provided in the present assignee's, Cleaveland/Price Inc., publication identified as Cleaveland/Price Instruction Book IB-AA10-169A.3, August 2023, entitled “AUTOLINE® In-Line Motor Operated Switch 69 kV-230 kV-2000 AMP Installation and Operating Instructions Type ILO-MV”. AUTOLINE® is a U.S. registered trademark of the present assignee, Cleaveland/Price Inc. The said Cleaveland/Price Instruction Book IB-AA10-169A.3, August 2023, entitled “AUTOLINE® In-Line Motor Operated Switch 69 kV-230 kV-2000 AMP Installation and Operating Instructions Type ILO-MV” is incorporated herein by reference in its entirety as though fully set forth.

The present invention relates to an improvement to the motorized high voltage in-line air break disconnect switches disclosed in said U.S. Pat. No. 9,881,755 B1 and said U.S. Pat. No. 9,966,207 B1, which are currently being manufactured by the present assignee, Cleaveland/Price Inc. At the present time these battery operated motorized switches, which are solar powered, have limited application in use to the southern portion of the United States of America where there is ample sun, since these switches only have three solar panels, attached to a motor housing enclosing a battery and a battery operated motor, that keep the battery charged.

The present assignee's motorized high voltage in-line air break disconnect switches as disclosed in said U.S. Pat. No. 9,881,755 B1 and said U.S. Pat. No. 9,966,207 B1, hang on the high voltage transmission line and can be opened or closed by radio command to disconnect the power or reroute the power to another load. These in-line switches must be able to open or close the high voltage circuit in all kinds of weather and specifically in ice conditions.

To operate reliably under ice conditions, the present assignee's motorized high voltage in-line air break disconnect switches, as disclosed in U.S. Pat. Nos. 9,881,755 B1 and 9,966,207 B1, have been provided with ice shields that keep the open and close electric contacts of the switch from being covered with thick ice, such as ¾ inch to 1 inch, and uses flat pan-like plates to shield the switch blade mating contacts from ice as shown in FIG. 2.

It is therefore an object of the present invention to provide an improved high voltage in-line air break disconnect switch that can operate reliably under ice conditions, by providing the necessary ice shielding that keeps the open and close electric contacts from being covered with thick ice and also, at the same time, providing the additional solar power needed for operating the in-line switch in northern climates where there is less sun energy available.

### SUMMARY OF THE INVENTION

The object of the invention is achieved by the elongated rotating motorized in-line high voltage air break disconnect switch of the present invention comprising a new unique solar panel ice shield unit including an improved ice shield with integral solar panels operatively mounted on the transmission line above the moving contact end of the elongated switch blade when the switch is in the final open electrically non-conductive switch position. The disclosed solar panel ice shield unit is attached directly to and supported by the transmission cable for northern climates, instead of the flat pan-like plate used solely for ice shielding as described above. Additionally, the motorized in-line high voltage air break disconnect switch may comprise at least one or more additional solar panel units that do not shield ice from the moving contact end of the elongated switch blade when the switch is in the final open electrically non-conductive switch position, but can provide additional solar energy if needed for northern climates, and which can also be attached directly to and supported by the transmission cable. Up to four such additional solar panel units is typical.

### BRIEF DESCRIPTION OF THE DRAWINGS

For a better understanding of the invention reference may be made to the accompanying drawings exemplary of embodiments of the invention, in which:

FIG. 1 shows a perspective view of a vertical break embodiment of the motorized in-line switch as disclosed in the said U.S. Pat. No. 9,881,755 B1 and said U.S. Pat. No. 9,966,207 B1;

FIG. 2 shows a perspective view of the same switch as shown in FIG. 1, but with flat pan-like plate ice shields for the open and closed positions of the switch with the switch shown closed;

FIG. 3 shows a perspective view of the same switch as shown in FIG. 2, partially broken away showing the switch motor, the switch motor battery, and the switch hinge end, and showing the flat pan-like plate ice shields for the open and closed positions of the switch, with the switch open and one of the flat pan-like plate ice shields covering the open blade contacts;

FIG. 4 shows a perspective view of the same switch as shown in FIG. 3 with the disclosed solar panel ice shield unit of the present invention clamped to the transmission line for supplying additional solar energy and for shielding the open blade contacts from ice build-up;

FIG. 5 shows a perspective view of an enlarged detail of the solar panel ice shield unit shown in FIG. 4, showing how the solar panel ice shield unit attaches to the transmission line with cable clamps, and showing the D.C., i.e., direct current, conductors that feed current from the solar panel ice shield unit to the battery within the motor housing; and,

FIG. 6 shows a perspective view of the same switch as shown in FIG. 4, but with additional solar panel unit units, not used for ice shielding, also attached directly to, and supported by the transmission line, the additional solar panel units used for collecting more solar energy for the far north areas. Up to four additional solar panel units are possible as needed for more energy.

### DETAILED DESCRIPTION OF THE INVENTION

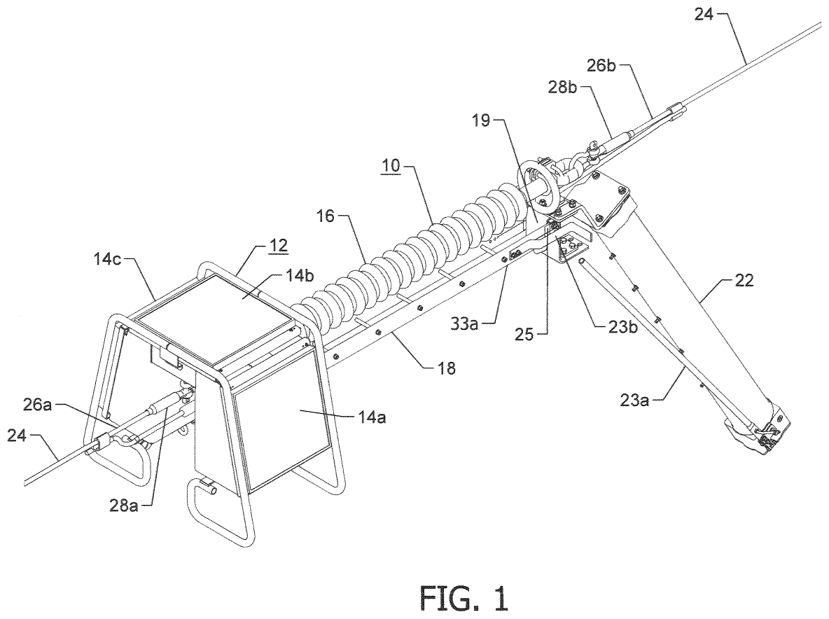

A vertical break motorized high voltage in-line air break disconnect switch 10 is shown in FIGS. 1, 2, and 3, as disclosed in the said U.S. Pat. No. 9,881,755 B1 and said U.S. Pat. No. 9,966,207 B1. The present invention is also applicable to a side break motorized high voltage in-line air break disconnect switch which is also disclosed in the said U.S. Pat. No. 9,881,755 B1 and said U.S. Pat. No. 9,966,207 B1. Although, such a side break switch is not shown in the present drawings.

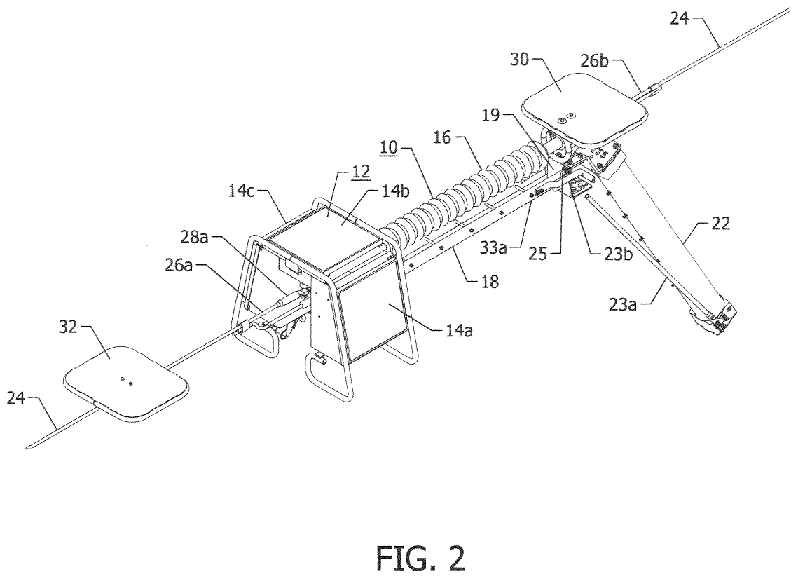

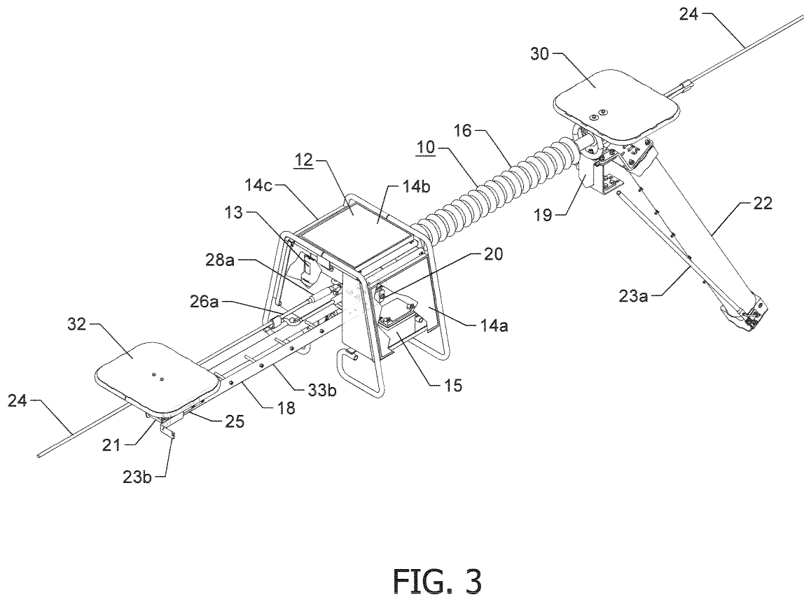

The motorized elongated rotating high voltage in-line air break disconnect switch 10 as shown in FIGS. 1 and 2 is shown in the closed electrically conductive position. FIG. 3 shows the vertical break disconnect switch 10 in the open electrically non-conductive position. The switch 10 as shown in FIG. 3, with the cut-away view, includes a motor housing 12 enclosing a battery operated switch motor 13. Solar panels 14a, 14b, and 14c are operatively attached to the motor housing 12 for charging the switch motor battery 15 enclosed in the housing 12. The in-line disconnect switch 10 includes a polymer elongated strain insulator 16 for support and to provide electric insulation for the open air gap between break jaw 19 and the housing 12. The switch 10 includes a vacuum interrupter 22 to interrupt load current without electric arcing as the switch opens at the break jaw contact 19. The switch 10 includes a hinge mounted elongated rotating switch blade 18 that includes a moving contact end 25 including moving contact 21 and moving arc horn 23b. The moving contact end 25 contacts the break jaw contact 19 in the closed conductive switch blade position 33a as shown in FIG. 1.

FIG. 3 shows the rotating switch blade 18 rotates about a hinge end 20 of the rotating switch blade 18 which is supported by the elongated strain insulator 16. The elongated rotating switch blade 18 in the electrically conductive switch position extends in parallel relationship with the elongated strain insulator 16.

As shown in FIG. 1, a transmission line 24 has been cut, resulting in two transmission line ends 26a, 26b. Each transmission line end 26a, 26b is respectively attached to strain cable fittings 28a, 28b which support the entire motorized switch 10 comprising strain insulator 16, the attached switch blade 18, the motor housing 12, the vacuum interrupter 22, and other elements of the switch 10. The vacuum interrupter 22 includes an actuating arm 23a. The moving arc horn 23b is attached to the moving switch blade 18.

FIG. 2 shows a pan ice shield 30 covering the break jaw 19 and the moving arc horn 23b to prevent ice build-up on these elements. The pan ice shield 30 is shaped like a pan-like plate. FIG. 3 also shows a similarly shaped pan ice shield 32 covering the moving contact end 25 of the switch blade 18 in a final open non-conductive switch blade position 33b to prevent ice build-up on the moving contact 21 and on the moving arc horn 23b. The pan ice shields 30 and 32 are typically made of aluminum. For further details of the motorized in-line switch 10 from 69 kV to 230 kV, reference may be made to the above-referenced present assignee's, Cleaveland/Price Inc., publication identified as Cleaveland/Price Instruction Book IB-AA10-169A.3, August 2023, entitled “AUTOLINE® In-Line Motor Operated Switch 69 kV-230 kV-2000 AMP Installation and Operating Instructions Type ILO-MV”.

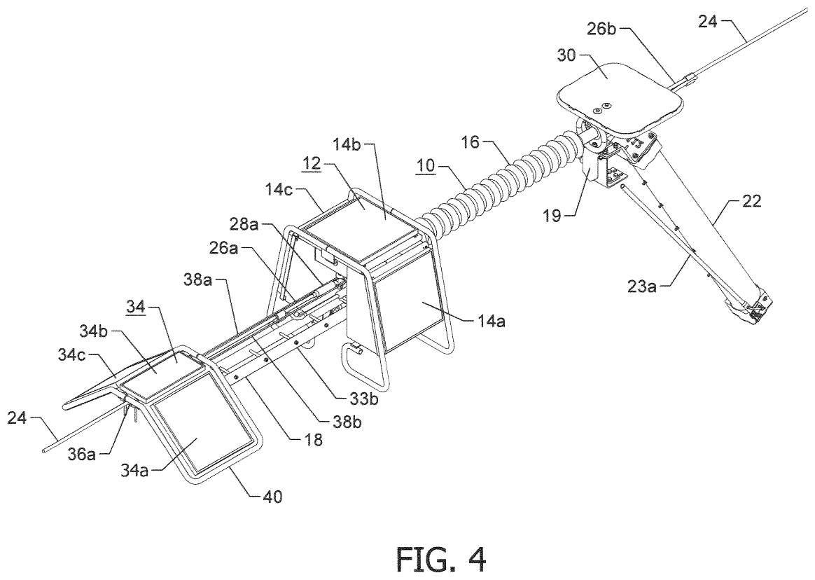

FIG. 4 shows one embodiment of the motorized high voltage in-line air break disconnect switch 10 of the present invention. The same reference numerals used in FIGS. 1, 2, and 3 to identify various components and details of the currently manufactured in-line switch 10 are also used in FIG. 4 to identify the same components and details. The in-line switch 10 shown in FIG. 4 shows the in-line switch 10 as shown in FIG. 3, but instead of the pan ice shield 32 as shown in FIG. 3, it has been replaced according to the present invention with solar panel ice shield unit 34.

The solar panel ice shield unit 34 includes at least one ice shield solar panel. In one embodiment of the invention three ice shield solar panels 34a, 34b, and 34c are arranged as shown in FIG. 4, in order to shield the moving contact end 25 (hidden under solar panel ice shield unit 34) of the switch blade 18 from harmful ice build-up, when the switch 10 is in the final open non-conductive position. The three ice shield solar panels 34a, 34b, and 34c are desirably arranged in an inverted V-configuration, as shown in FIG. 4, configured to act as an ice shield for the moving contact end 25 of the switch blade 18, while simultaneously configured to capture solar energy. The moving contact end 25 is hidden by the solar panel ice shield unit 34 in FIG. 4, but the moving contact end 25 is shown in FIG. 3. The three ice shield solar panels 34a, 34b, and 34c for a 69 kV to a 230 KV for such a motorized in-line switch may have the same dimensions.

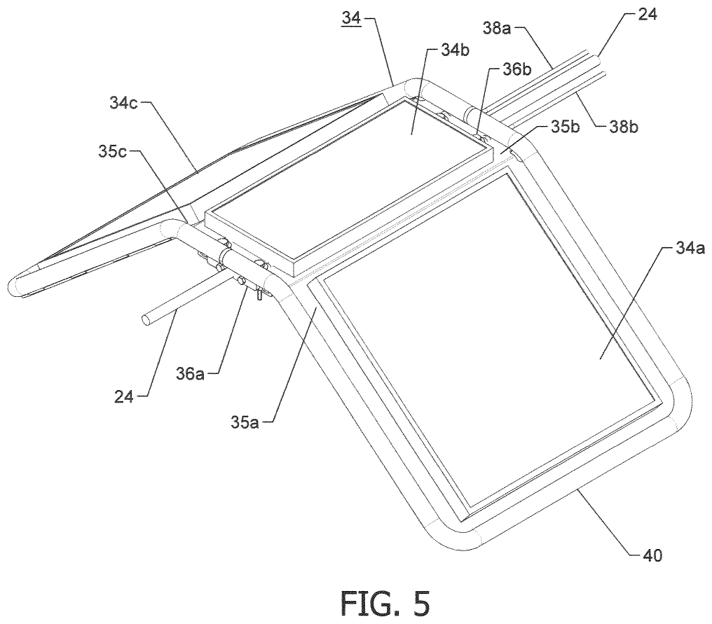

The solar panel ice shield unit 34 may also include a solar panel ice shield unit support frame 40 for supporting the three ice shield solar panels 34a, 34b, and 34c. Each ice shield solar panel 34a, 34b, and 34c is respectively, preferably, mounted on a plate 35a, 35b, and 35c, which is attached to the solar panel ice shield unit support frame 40, as can be seen in FIG. 5. The plates 35a, 35b, 36c may be made of aluminum and welded to the solar panel ice shield unit support frame 40, for example.

The three ice shield solar panels 34a, 34b, 34c may have a combined maximum electric output of 50 watts. The solar panel ice shield unit support frame 40 can be typically made of aluminum tube and serves as a corona ring to prevent electric stress at high voltage. The solar panel ice shield unit support frame 40 can be attached by conductor clamps 36a, 36b to the transmission line 24, as shown in FIG. 5. D.C. cables 38a, 38b feed direct current to energize the switch motor battery 15 for powering the switch motor 13 housed in the motor housing 12. The D.C. cables 38a, 38b can be held by their terminations between the connection at the respective ice shield solar panels 34a, 34b, and 34c and the battery 15. The terminations are not shown in the drawings.

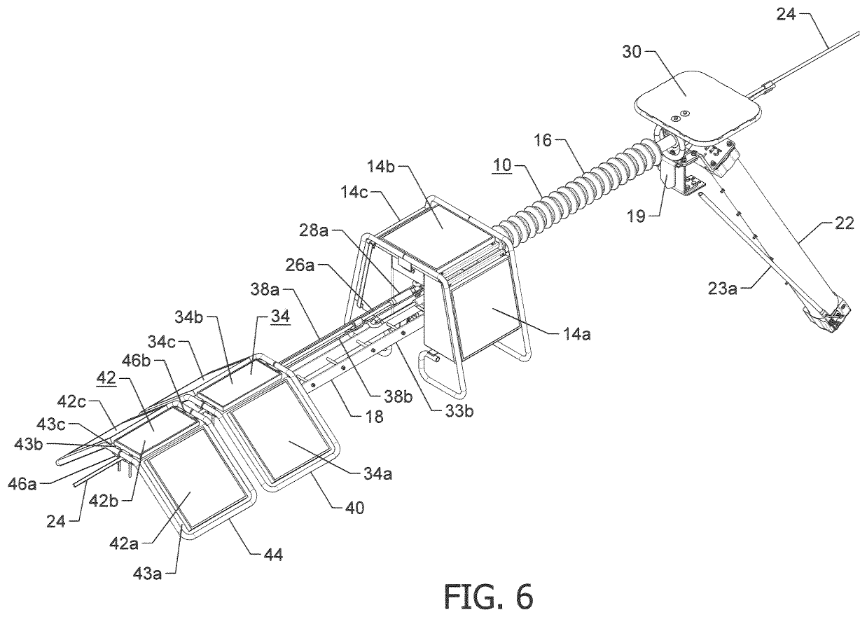

FIG. 6 shows another embodiment of the present invention, where the in-line switch 10 includes an additional solar panel unit 42 used for collecting more sun energy when the in-line switch 10 is installed in the north areas of the United States, for example. The additional solar panel unit 42 is not used for ice shielding. The additional solar panel unit 42 includes three non-ice shield solar panels 42a, 42b, and 42c, for example, which may be identical to the solar panels 34a, 34b, and 34c used for the solar panel ice shield unit 34 described above. Each non-ice shield solar panel 42a, 42b, and 42c is respectively preferably mounted on non-ice shield solar panel mounting 43a, 43b, and 43c, which are attached to the additional solar panel unit support frame 44, as can be seen in FIG. 6. The non-ice shield solar panels 42a, 42b, and 42c also may be attached to transmission line 24 by the additional solar panel unit support frame 44 in the same manner as described above for solar panel ice shield unit solar panels 34a, 34b, 34c. The additional solar panel unit support frame 44 may be attached to the transmission line 24 by similar additional clamps 46a, 46b in the same manner as described above for the solar panel ice shield clamps 36a, 36b. The same D.C. cables used for the solar panel ice shield unit 34 described above can also be used to feed direct current from the additional solar panel unit 42 to the switch motor battery 15.

The three non-ice shield solar panels 42a, 42b, and 42c of the additional solar panel unit 42 may also be arranged in the same inverted V-configuration as shown in FIG. 6 for the ice shield solar panels 34a, 34b, and 34c of the solar panel ice shield unit 34. Up to four additional solar panel units 42 is possible. Of course, the ice shield solar panel unit 34 and one or more of the non-ice shield additional solar panel units 42 may be used in addition to the solar panels attached to housing 12 to charge the battery 15, for increased charging in the north United States.

### LIST OF REFERENCE NUMERALS

10 elongated rotating motorized high voltage in-line air break disconnect switch
12 motor housing
13 switch motor
14a motor housing solar panel
14b motor housing solar panel
14c motor housing solar panel
15 switch motor battery
16 polymer elongated strain insulator
18 hinge mounted elongated rotating switch blade
19 break jaw contact terminal
20 hinge end of 18
21 moving contact of 18
22 vacuum interrupter
23a actuating arm of 22
23b moving arc horn
24 transmission line
25 moving contact end of 18
26a transmission line end
26b transmission line end
28a strain cable fitting
28b strain cable fitting
30 pan ice shield jaw end
32 pan ice shield for final open blade position
33a closed conductive switch blade position
33b final open non-conductive switch blade position
34 solar panel ice shield unit
34a ice shield solar panel of 34
34b ice shield solar panel of 34
34c ice shield solar panel of 34
35a solar panel mounting plate
35b solar panel mounting plate
35c solar panel mounting plate
36a solar panel ice shield unit transmission line conductor clamp
36b solar panel ice shield unit transmission line conductor clamp
38a D.C. cable conductor in circuit with switch motor battery 15
38b D.C. cable conductor in circuit with switch motor battery 15
40 solar panel ice shield unit support frame
42 additional solar panel unit
42a non-ice shield solar panel of 42
42b non-ice shield solar panel of 42
42c non-ice shield solar panel of 42
43a non-ice shield solar panel mounting plate
43b non-ice shield solar panel mounting plate
43c non-ice shield solar panel mounting plate
44 additional solar panel unit support frame
46a additional solar panel unit transmission line conductor clamp
46b additional solar panel unit transmission line conductor clamp

Of course variations from the foregoing embodiments are possible without departing from the scope of the invention.

What is claimed is:

1. A high voltage motorized in-line air break disconnect switch operatively supported and suspended by and mounted in-line with an electric power line conductor, the high voltage motorized in-line air break disconnect switch having an open electrically non-conductive position and a closed electrically conductive position, the high voltage motorized in-line air break disconnect switch comprising:
an elongated strain insulator operatively supported and suspended by and between a first cut end and a second cut end of the electric power line conductor,
an elongated rotating switch blade including a hinge contact end and a moving contact end, the elongated rotating switch blade in the closed electrically conductive switch position in parallel relationship with the elongated strain insulator, the hinge contact end of the elongated rotating switch blade supported by the elongated strain insulator,
a hinge contact terminal in operative electric circuit arrangement with the elongated rotating switch blade at the hinge contact end thereof,
the hinge contact terminal including an integral hinge member and a break jaw contact terminal including an integral break jaw operatively supported by the elongated strain insulator at opposite ends thereof,
the moving contact end of the elongated rotating switch blade in operative electric circuit arrangement with the break jaw contact terminal when the high voltage motorized in-line air break disconnect switch is in the closed conductive position,
the elongated rotating switch blade in the open electrically non-conductive switch position rotatable about the integral hinge member to a final open electrically non-conductive switch position in parallel relationship with the electric power line conductor,
a first electrical connection in operative electric circuit arrangement between the electric power line conductor and the hinge contact terminal and a second electrical connection in operative electric circuit arrangement between the electric power line conductor and the break jaw contact terminal,
a motor in operative arrangement with the hinge contact end of the elongated rotating switch blade to rotate the elongated rotating switch blade upon the motor actuation into operative electric closed circuit arrangement with the break jaw contact in the closed conductive switch position and to rotate upon motor actuation out of operative electric closed circuit arrangement with the break jaw contact into the final open non-conductive switch position,
a motor housing operatively supported by the electric power line conductor proximate the hinge end, the motor housing enclosing the motor, the motor housing enclosing at least one solar charged battery for supplying energy to the motor, the motor housing including solar panels operatively attached to the exterior of the motor housing for solar charging of the at least one battery,
a solar panel ice shield unit including at least one ice shield solar panel operatively attached to the electric power line conductor and the at least one ice shield solar panel connected in electrical operative arrangement with the at least one solar charged battery and the motor for increased solar charging of the battery, and,
the solar panel ice shield unit configured to shield the moving contact end of the elongated switch blade from ice build-up when the high voltage motorized in-line air break disconnect switch is in the final open electrically non-conductive switch position.

2. The conductor suspended high voltage motorized in-line air break disconnect switch of claim 1, further comprising a solar panel ice shield unit support frame configured to support the at least one ice shield solar panel.

3. The conductor suspended high voltage motorized in-line air break disconnect switch of claim 2, wherein the solar panel ice shield unit support frame includes round tubular frame material configured to prevent electric corona.

4. The conductor suspended high voltage motorized in-line air break disconnect switch of claim 2, wherein the solar panel ice shield unit support frame is in operative attachment to the electric power line conductor.

5. The conductor suspended high voltage motorized in-line air break disconnect switch of claim 1, further comprising direct current cables in operative electrical connection between the at least one ice shield solar panel and the at least one battery.

6. The conductor suspended high voltage motorized in-line air break disconnect switch of claim 2, further comprising at least one clamp configured to clamp the electric power line conductor to the solar panel ice shield unit support frame.

7. The conductor suspended high voltage motorized in-line air break disconnect switch of claim 2, wherein the solar panel ice shield unit support frame is made of aluminum.

8. The conductor suspended high voltage motorized in-line air break disconnect switch of claim 1, further comprising at least one non-ice shield additional solar panel unit including at least one non-ice shield solar panel, the at least one non-ice shield additional solar panel unit operatively attached to the electric power line conductor, the at least one non-ice shield additional solar panel unit configured to collect more solar energy for electric charging of the at least one battery.

9. The conductor suspended high voltage motorized in-line air break disconnect switch of claim 8, further comprising an additional non-ice shield solar unit support frame configured to support the at least one non-ice shield additional solar panel, the additional non-ice shield solar unit support frame in operative attachment to the electric power line conductor.

10. The conductor suspended high voltage motorized in-line air break disconnect switch of claim 8, further comprising direct current cables in operative electrical connection between the at least one non-ice shield additional solar panel and the at least one battery.

11. The conductor suspended high voltage motorized in-line air break disconnect switch of claim 9, further comprising at least one additional clamp configured to clamp the electric power line conductor to the additional non-ice shield solar panel unit support frame.

12. The conductor suspended high voltage motorized in-line air break disconnect switch of claim 9, wherein the non-ice shield solar panel unit support frame is made of aluminum.

13. The conductor suspended high voltage motorized in-line air break disconnect switch of claim 8, wherein the solar panel ice shield unit and the at least one non-ice shield additional solar panel unit are arranged adjacent to each other proximate the moving contact end of the elongated rotating switch blade in the final open non-conductive switch blade position.

14. The conductor suspended high voltage motorized in-line air break disconnect switch of claim 1, wherein the solar panel ice shield unit further comprises at least one ice shield solar panel mounting plate, each ice shield solar panel mounting plate having one of the at least one ice shield solar panels operatively attached.

15. The conductor suspended high voltage motorized in-line air break disconnect switch of claim 9, wherein the at least one non-ice shield additional solar panel unit each further comprises at least one non-ice shield solar panel mounting plate, each non-ice shield solar panel mounting plate having one of the at least one non-ice solar panels operatively attached.
